(19) United States
(12) Patent Application Publication
(10) Pub. No.: US 2024/0067225 A1
(43) Pub. Date: Feb. 29, 2024

(54) INFORMATION PROCESSING APPARATUS, NON-TRANSITORY COMPUTER READABLE MEDIUM, AND INFORMATION PROCESSING METHOD

(71) Applicant: TOYOTA JIDOSHA KABUSHIKI KAISHA, Toyota-shi (JP)

(72) Inventors: Yoshikazu JIKUHARA, Miyoshi-shi (JP); Shin SAKURADA, Toyota-shi (JP); Tomokazu MAYA, Nagoya-shi (JP); Hiroyuki BANDAI, Toyota-shi (JP); Hiromitsu FUJII, Kariya-shi (JP)

(21) Appl. No.: 18/455,885

(22) Filed: Aug. 25, 2023

(30) Foreign Application Priority Data
Aug. 26, 2022 (JP) 2022-135352

(51) Int. Cl. B60W 60/00; B60W 40/08

(52) U.S. Cl. CPC B60W 60/0025; B60W 40/08; B60W 2540/041; B60W 2540/043

(57) ABSTRACT

An information processing apparatus configured to manage a vehicle with a cafeteria facility, the information processing apparatus includes a controller configured to acquire dispatch destination information including a designated location and a designated time period, and command the vehicle to be dispatched to the designated location in the designated time period.

### CROSS-REFERENCE TO RELATED APPLICATION

This application claims priority to Japanese Patent Application No. 2022-135352 filed on Aug. 26, 2022, the entire contents of which are incorporated herein by reference.

### TECHNICAL FIELD

The present disclosure relates to an information processing apparatus, a program, and an information processing method.

### BACKGROUND

Various technologies for vehicle dispatch have been studied.

For example, Patent Literature (PTL) 1 discloses technology for dispatching vehicles of carriers, such as cafeteria automobile providers, in response to calls.

### CITATION LIST

### Patent Literature

PTL 1: JP 2012-108913 A

### SUMMARY

PTL 1 discloses dispatching a vehicle of a cafeteria automobile provider in response to a call, but does not propose any method for providing meals to workers and the like (hereinafter referred to as “workers”) who work at a factory, plant, commercial facility, office, or the like (hereinafter referred to as “workplace”). Providing, at workplaces, cafeteria facilities that can be used by workers enables to serve meals to the workers. However, there are problems in terms of space and cost to provide such cafeteria facilities. Thus, there is room for improvement with respect to technology for providing meals to workers at workplaces.

It would be helpful to improve technology for providing meals to workers at workplaces.

An information processing apparatus according to an embodiment of the present disclosure is an information processing apparatus configured to manage a vehicle with a cafeteria facility, the information processing apparatus including a controller configured to:
acquire dispatch destination information including a designated location and a designated time period; and
command the vehicle to be dispatched to the designated location in the designated time period.

A program according to an embodiment of the present disclosure is configured to cause an information processing apparatus to execute operations, the information processing apparatus being configured to manage a vehicle with a cafeteria facility, the operations including:
acquiring dispatch destination information including a designated location and a designated time period; and
commanding the vehicle to be dispatched to the designated location in the designated time period.

An information processing method according to an embodiment of the present disclosure is an information processing method performed by an information processing apparatus configured to manage a vehicle with a cafeteria facility, the information processing method including:
acquiring dispatch destination information including a designated location and a designated time period; and
commanding the vehicle to be dispatched to the designated location in the designated time period.

According to the present disclosure, technology for providing meals to workers at workplaces can be improved.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a vehicle according to the embodiment of the present disclosure;

FIG. 3 is a block diagram illustrating a configuration of an information processing apparatus according to the embodiment of the present disclosure;

FIG. 4 is a block diagram illustrating a configuration of a terminal apparatus according to the embodiment of the present disclosure;

FIG. 5 is a flowchart illustrating operations of the system according to the embodiment of the present disclosure; and

FIG. 6 is a flowchart illustrating a variation of the operations of the system according to the embodiment of the present disclosure.

### DETAILED DESCRIPTION

An embodiment of the present disclosure will be described below with reference to the drawings.

### Outline of Embodiment

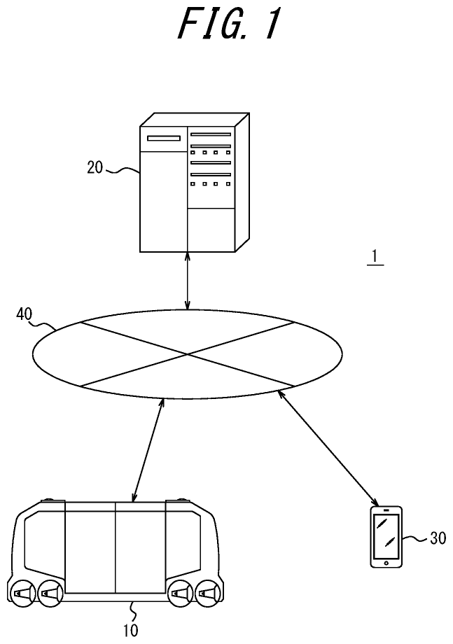

With reference to FIG. 1, a cafeteria vehicle dispatch system 1 according to the embodiment of the present disclosure will be described. The cafeteria vehicle dispatch system 1 includes a vehicle 10, an information processing apparatus 20, and a terminal apparatus 30. The vehicle 10, the information processing apparatus 20, and the terminal apparatus 30 are communicably connected to a network 40 including, for example, the Internet, a mobile communication network, and the like.

The vehicle 10 is an automobile, for example, but is not limited to this, and may be any appropriate vehicle. The vehicle 10 is, for example, a gasoline automobile, a battery electric vehicle (BEV), a hybrid electric vehicle (HEV), a plug-in hybrid electric vehicle (PHEV), a fuel cell electric vehicle (FCEV), or the like, but is not limited to these. The vehicle 10 has a cafeteria facility. The number of vehicles 10 provided in the cafeteria vehicle dispatch system 1 may be freely determined. The vehicle 10 may be a manned vehicle or any autonomous vehicle that travels unmanned.

The information processing apparatus 20 is, for example, a dedicated computer configured to function as a server. The information processing apparatus 20 may be a general purpose personal computer (PC). The information processing apparatus 20 can communicate with the vehicle 10 and the terminal apparatus 30 via the network 40.

The terminal apparatus 30 is, for example, a general purpose electronic device such as a smartphone or a general purpose PC. The terminal apparatus 30 is an electronic device used, for example, by workers who use the cafeteria facility of the vehicle 10, or by a manager of such workers. The terminal apparatus 30 is not limited to these, and may be an electronic device that is dedicated to the cafeteria vehicle dispatch system 1.

First, an outline of the present embodiment will be described, and details thereof will be described later. The information processing apparatus manages the vehicle 10 with the cafeteria facility. The terminal apparatus transmits, to the information processing apparatus 20, dispatch destination information for use of the cafeteria facility. The dispatch destination information includes a designated location and a designated time period. The information processing apparatus 20 acquires the dispatch destination information from, for example, the terminal apparatus 30. The information processing apparatus 20 then, based on the dispatch destination information, commands the vehicle 10 to move to a workplace. Specifically, the information processing apparatus 20 commands the vehicle 10 to be dispatched to the designated location in the designated time period.

Thus, according to the present embodiment, the information processing apparatus 20 acquires dispatch destination information and, based on the dispatch destination information, dispatches the vehicle 10 with the cafeteria facility to a designated location in a designated time period. Accordingly, for example, even when a workplace does not have a cafeteria facility, workers at the workplace can use a cafeteria facility by designating the workplace as dispatch destination information. In other words, the vehicle can substitute for a cafeteria. Therefore, technology for providing meals to workers at workplaces can be improved in that, as long as the vehicle 10 can be dispatched to a workplace, workers at the workplace can be encouraged to use the cafeteria facility.

Next, configurations of the cafeteria vehicle dispatch system 1 will be described in detail.

(Configuration of Vehicle)

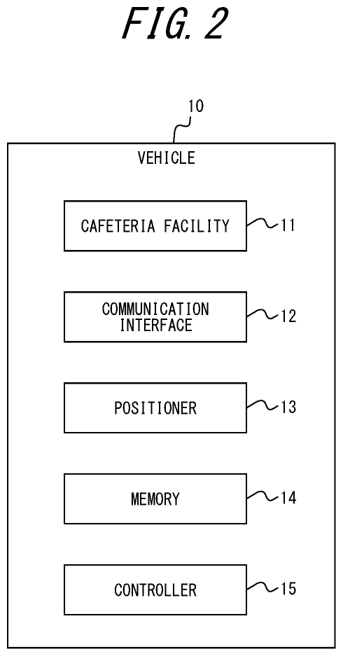

As illustrated in FIG. 2, the vehicle 10 includes a cafeteria facility 11, a communication interface 12, a positioner 13, a memory 14, and a controller 15.

The cafeteria facility 11 includes any equipment for serving meals. The cafeteria facility 11 may include tables and seats that allow eating and drinking inside the vehicle 10. Alternatively, the cafeteria facility 11 may include equipment for serving food such as bread, rice, noodles, main dishes, side dishes, or the like.

The communication interface 12 includes at least one communication interface for connecting to the network 40. The communication interface is compliant with, for example, mobile communication standards such as the 4th generation (4G) standard or the 5th generation (5G) standard, but is not limited to these. In the present embodiment, the vehicle 10 communicates with the information processing apparatus 20 and the terminal apparatus 30 via the communication interface 12 and the network 40.

The positioner 13 includes one or more apparatuses configured to acquire positional information on the vehicle 10. Specifically, the positioner 13 includes a receiver corresponding to the Global Positioning System (GPS), for example, but is not limited to this, and may include a receiver corresponding to any satellite positioning system. The positioner 13 may acquire the positional information on the vehicle 10 continually, periodically, or non-periodically.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information used for operations of the vehicle 10. For example, the memory 14 may store a system program, an application program, embedded software, and the like. The information stored in the memory 14 may be updated with, for example, information acquired from the network 40 via the communication interface 12.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire vehicle 10.

(Configuration of Information Processing Apparatus)

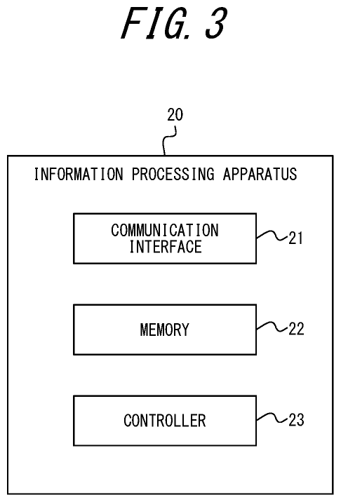

As illustrated in FIG. 3, the information processing apparatus 20 includes a communication interface 21, a memory 22, and a controller 23.

The communication interface 21 includes at least one communication interface for connecting to the network 40. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the vehicle 10 and the terminal apparatus 30 via the communication interface 21 and the network 40. The information processing apparatus 20 may communicate via the communication interface 21 and the network 40 with vehicles other than the vehicle 10 according to the present embodiment, such as automobiles that do not have power supply capabilities, for example.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, map information, and the like. The information stored in the memory 22 may be updated with, for example, information acquired from the network 40 via the communication interface 21.

The controller 23 includes at least one processor, at least one programmable circuit, at least one dedicated circuit, or a combination of these. The controller 23 controls operations of the entire information processing apparatus 20.

(Configuration of Terminal Apparatus)

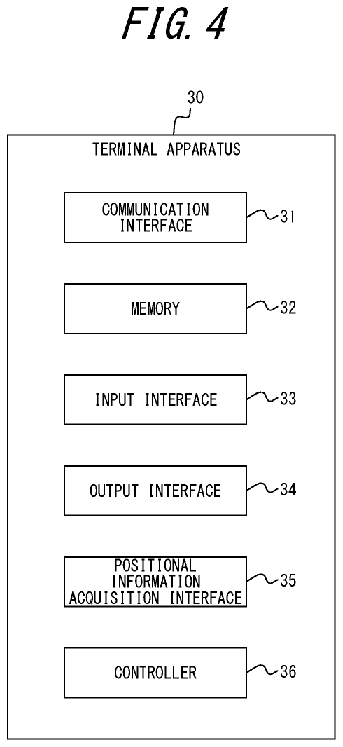

As illustrated in FIG. 4, the terminal apparatus 30 include a communication interface 31, a memory 32, an input interface 33, an output interface 34, a positional information acquisition interface 35, and a controller 36.

The communication interface 31 includes a communication module connected to the network 40. For example, the communication interface 31 may include a communication module compliant with mobile communication standards such as the 4th generation (4G) standards and the 5th generation (5G) standards. In an embodiment, the terminal apparatus 30 connects to the network 40 via the communication interface 31. The communication interface 31 transmits and receives various information via the network 40.

The memory 32 is, for example, a semi-conductor memory, a magnetic memory, an optical memory, or the like, but is not limited to these. The memory 32 may function as, for example, a main memory, an auxiliary memory, or a cache memory. The memory 32 stores any information to be used for operations of the terminal apparatus 30. For example, the memory 32 may store a system program, an application program, various types of information received by the communication interface 21, and the like. The information stored in the memory 32 may be updated with information received from the network 40 via the communication interface 31, for example.

The input interface 33 includes at least one input interface for detecting user input to acquire input information based on an operation by a user. The input interface 33 is, for example, a physical key, a capacitive key, a touch screen integrally provided with a display of the output interface 34, a microphone for receiving audio input, or the like, but is not limited to these.

The output interface 34 includes at least one output interface for outputting information to notify the user of the information. The output interface 34 is, for example, a display for outputting the information in the form of an image, a speaker for outputting the information in the form of audio, or the like, but is not limited to these.

The positional information acquisition interface 35 includes at least one device for acquiring positional information on the terminal apparatus 30. Specifically, the positional information acquisition interface 35 includes a receiver corresponding to the Global Positioning System (GPS), for example, but is not limited to this, and may include a receiver corresponding to any satellite positioning system. The positional information acquisition interface may acquire the positional information on the terminal apparatus 30 continually, periodically, or non-periodically.

The controller 36 includes at least one processor, at least one programmable circuit, at least one dedicated circuit, or a combination of these. The controller 36 controls operations of the entire terminal apparatus 30.

(Operations of Cafeteria Vehicle Dispatch System)

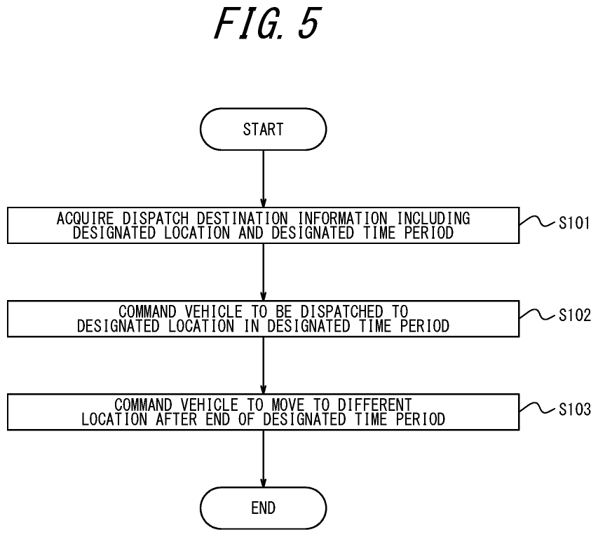

Operations of the cafeteria vehicle dispatch system 1 according to the present embodiment will be described with reference to FIG. 5.

Step S101: The controller 23 of the information processing apparatus acquires dispatch destination information including a designated location and a designated time period. The designated location is, for example, location information on a workplace. The location information on the workplace includes an address, latitude, and longitude. For example, the designated location may be location information within a certain distance from a site of the workplace. The designated time period includes a designated start time and a designated end time. For example, the designated start and end times are 12:00 p.m. and 1:00 p.m., respectively.

Any method can be employed to acquire the dispatch destination information. For example, the controller 23 may acquire the dispatch destination information from the terminal apparatus 30 via the communication interface 21 and the network 40. Alternatively, the controller 23 may acquire the dispatch destination information from the memory 22. In other words, the dispatch destination information may be stored in a database or the like in the memory 22 of the information processing apparatus 20, and the controller 23 may acquire the dispatch destination information from the database.

Step S102: Based on the designated location and designated time period included in the dispatch destination information, the controller 23 commands the vehicle 10 to be dispatched to the designated location in the designated time period. In other words, the controller 23 commands the vehicle 10 to move to the workplace so that workers can use the cafeteria facility 11 in such designated time period.

Step S103: The controller 23 commands the vehicle 10 to move to a different location from the designated location at an end of the designated time period. The different location may be a location of a dispatcher. Alternatively, the different location may be a different dispatch destination (different workplace) from the designated location.

Thus, the information processing apparatus 20 acquires dispatch destination information and commands the vehicle 10 to be dispatched to a designated location in a designated time period based on the dispatch destination information. Therefore, based on the dispatch destination information, workers who need a cafeteria facility can be encouraged to use the cafeteria facility.

(Variation in Operations of Cafeteria Vehicle Dispatch System)

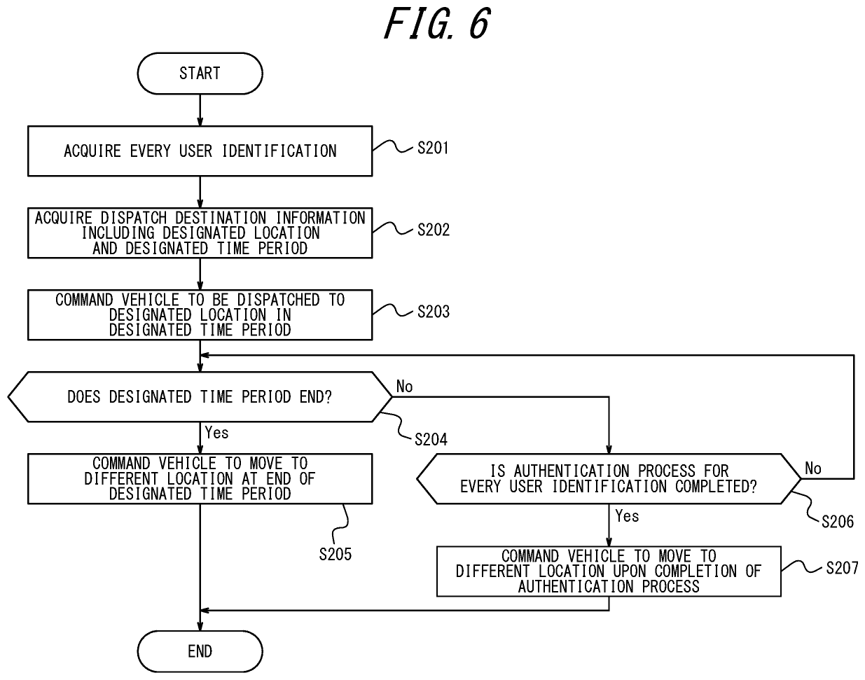

A variation in the operations of the cafeteria vehicle dispatch system 1 according to the present embodiment will be described with reference to FIG. 6. In the cafeteria vehicle dispatch system 1 according to the variation, every user identification corresponding to every worker who plans to use the cafeteria facility 11 is registered in advance. When a meal is served at a designated location, the cafeteria vehicle dispatch system 1 requires each worker to authenticate his/her user identification. The cafeteria vehicle dispatch system 1 grasps a usage status of the cafeteria facility 11 based on the pre-registered every user identification and an authentication process.

Step S201: The controller 23 of the information processing apparatus acquires every user identification corresponding to every worker who plans to use the cafeteria facility 11 at a designated location.

Any method can be used to acquire every user identification. For example, the controller 23 may receive every user identification from the terminal apparatus 30 via the communication interface 21 and the network 40. Alternatively, the controller 23 may receive every user identification from an external server via the communication interface 21 and the network 40.

Step S202: The controller 23 acquires dispatch destination information including the designated location and a designated time period.

Step S203: Based on the designated location and designated time period included in the dispatch destination information, the controller 23 commands the vehicle 10 to be dispatched to the designated location in the designated time period. In other words, the controller 23 commands the vehicle 10 to move to the workplace so that workers can use the cafeteria facility 11 in such designated time period.

Step S204: The controller 23 determines whether the designated time period ends. In other words, the controller 23 determines whether the current time is at an end of the designated time period. When it is determined that the designated time period ends, the process proceeds to step S205. When, on the other hand, it is determined that the designated time period does not end, the process proceeds to step S206.

Step S205: The controller 23 commands the vehicle 10 to move to a different location from the designated location at the end of the designated time period.

Step S206: The controller 23 determines whether an authentication process for every user identification is completed. As described above, the authentication process is a process that is performed when a meal is served at the designated location. For example, the authentication process is performed after each worker finishes eating. Alternatively, the authentication process may be performed at the time of accounting for the meal to each worker. When the authentication process for every user identification is completed, the process proceeds to step S207. When the authentication process for every user identification is not completed, the process proceeds to step S204.

Step S207: The controller 23 commands the vehicle 10 to move to a different location from the designated location upon the completion of authentication of every user identification. In other words, when the authentication process for every user identification is completed before the end of the designated time period, the controller 23 commands the vehicle 10 to move to a different location upon the completion of the authentication process.

As described above, the information processing apparatus 20 acquires dispatch destination information and commands the vehicle 10 to be dispatched to a designated location in a designated time period based on the dispatch destination information. Therefore, based on the dispatch destination information, workers who need a cafeteria facility can be encouraged to use the cafeteria facility. The information processing apparatus 20 acquires every user identification. When the authentication process for every user identification is completed before an end of the designated time period, based on the authentication process of each worker's user identification, the information processing apparatus 20 commands the vehicle 10 to move to a different location before the end of the designated time period. This improves technology for serving meals at workplaces in that meals can be served more efficiently without keeping the vehicle 10 waiting until the end of the designated time period when servings of meals to all the users are completed.

Here, in step S206, the controller 23 may determine whether the authentication process for every user identification, except a user identification for a worker who has notified a plan cancellation, is completed. The plan cancellation is notification information that a worker who has planned to use the cafeteria facility 11 at the designated location cancels the plan. Any method can be used to acquire the plan cancellation. For example, the controller 23 may acquire the plan cancellation from the terminal apparatus 30 via the communication interface 21 and the network 40. Alternatively, the controller 23 may receive the plan cancellation from an external server via the communication interface 21 and the network 40. As described above, the information processing apparatus 20 acquires a plan cancellation and, based on the authentication process for each worker's user identification, when the authentication process for every user identification, except a user identification for a worker with the plan cancellation, is completed before an end of a designated time period, the information processing apparatus 20 commands the vehicle 10 to move to a different location before the end of the designated time period. This improves technology for serving meals at workplaces in that meals can be served more efficiently without keeping the vehicle 10 waiting until the end of the designated time period when servings of meals to all the workers, except the worker with the plan cancellation, are completed.

Here in step S207, the controller 23 commands the vehicle 10 to move to a different location from the designated location upon the completion of authentication of every user identification, but is not limited to this. When the authentication process for every user identification is completed before the end of the designated time period, the controller 23 may command the vehicle to move to a different location after a first predetermined time from the completion of the authentication process. The first predetermined time is, for example, 30 minutes. For example, when the authentication process is performed before starting a worker's meal and the worker takes his/her meal at the cafeteria facility 11 in the vehicle 10, the vehicle 10 stays for the first predetermined time until the worker finishes eating. This makes it possible to command to the vehicle 10 to move at an appropriate time after finishing a meal. Even though after the first predetermined time from the completion of the authentication process is after the end of the designated time period, the controller 23 may command the vehicle 10 to move to a different location after the first predetermined time from the completion of the authentication process, when the authentication process for every user identification is completed before the end of the designated time period. In other words, when the authentication process for every user identification is completed before the end of the designated time period, the controller 23 may command the vehicle 10 to move to a different location after the first predetermined time from the completion of the authentication process, regardless of an end time of the designated time period.

In step S206, the controller 23 may determine whether the authentication process for every user identification, except a user identification for a worker with a plan cancellation, is completed, and further in step S207, the controller 23 may command the vehicle 10 to move to a different location after the first predetermined time from the completion of the authentication process.

When the authentication process for every user identification is not completed in step S206, the controller 23 may notify an alert to a worker who has not been authenticated, among the workers who have planned to use the cafeteria facility 11. Specifically, for example, the controller 23 may determine whether the authentication process for multiple user identifications is completed before a second predetermined time of the end of the designated time period. The second predetermined time is, for example, 10 minutes. When the authentication process for the multiple user identifications is not completed before the second predetermined time of the end of the designated time period, the controller 23 outputs an alert to workers with user identifications for which the authentication process has not ended. This allows serving meals at workplaces more reliably.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented. For example, a navigation apparatus mounted in the vehicle 10 may be equipped with some or all of the components of the information processing apparatus 20.

For example, an embodiment in which a general purpose computer functions as the information processing apparatus 20 according to the above embodiment can also be implemented. Specifically, a program in which processes for realizing the functions of the information processing apparatus according to the above embodiment are written may be stored in a memory of a general purpose computer, and the program may be read and executed by a processor. Accordingly, the present disclosure can also be implemented as a program executable by a processor, or a non-transitory computer readable medium storing the program.

For example, a configuration that causes a general purpose electronic device such as a smartphone, a computer, or the like to function as the information processing apparatus 20 according to the embodiment described above is possible. Specifically, a program in which processes for realizing the functions of the information processing apparatus 20 or the like according to the embodiment are written may be stored in a memory of the electronic device, and the program may be read and executed by a processor of the electronic device. Accordingly, in an embodiment, the present disclosure can also be implemented as a program executable by a processor.

Examples of some embodiments of the present disclosure are described below. However, it should be noted that the embodiments of the present disclosure are not limited to these examples.

[Appendix 1] An information processing apparatus configured to manage a vehicle with a cafeteria facility, the information processing apparatus comprising a controller configured to:
acquire dispatch destination information including a designated location and a designated time period; and
command the vehicle to be dispatched to the designated location in the designated time period.

[Appendix 2] The information processing apparatus according to appendix 1, wherein the controller is configured to command the vehicle to move to a different location from the designated location at an end of the designated time period.

[Appendix 3] The information processing apparatus according to appendix 1 or 2, wherein the controller is configured to:
acquire every user identification for every worker who plans to use the cafeteria facility at the designated location; and
when an authentication process for every user identification is completed before an end of the designated time period, commanding the vehicle to move to a different location upon completion of the authentication process.

[Appendix 4] The information processing apparatus according to appendix 1 or 2, wherein the controller is configured to:
acquire every user identification for every worker who plans to use the cafeteria facility at the designated location; and
when an authentication process for every user identification is completed before an end of the designated time period, commanding the vehicle to move to a different location after a first predetermined time from completion of the authentication process.

[Appendix 5] The information processing apparatus according to appendix 1 or 2, wherein the controller is configured to:
acquire every user identification for every worker who plans to use the cafeteria facility at the designated location; and
when an authentication process for every user identification, except a user identification for a worker who has notified a plan cancellation, is completed before an end of the designated time period, commanding the vehicle to move to a different location upon completion of the authentication process.

[Appendix 6] The information processing apparatus according to appendix 1 or 2, wherein the controller is configured to:
acquire every user identification for every worker who plans to use the cafeteria facility at the designated location; and
when an authentication process for every user identification, except a user identification for a worker who has notified a plan cancellation, is completed before an end of the designated time period, commanding the vehicle to move to a different location after a first predetermined time from completion of the authentication process.

[Appendix 7] The information processing apparatus according to any one of appendices 3 to 6, wherein when the authentication process for every user identification is not completed before a second predetermined time of the end of the designated time period, the controller is configured to output an alert to a worker with a user identification for which the authentication process has not ended.

[Appendix 8] A program configured to cause an information processing apparatus to execute operations, the information processing apparatus being configured to manage a vehicle with a cafeteria facility, the operations comprising:
acquiring dispatch destination information including a designated location and a designated time period; and
commanding the vehicle to be dispatched to the designated location in the designated time period.

[Appendix 9] The program according to appendix 8, wherein the operations comprise commanding the vehicle to move to a different location from the designated location at an end of the designated time period.

[Appendix 10] The program according to appendix 8 or 9, wherein
the dispatch destination information includes every user identification for every worker who plans to use the cafeteria facility at the designated location, and
the operations comprise, when an authentication process for every user identification is completed before an end of the designated time period, commanding the vehicle to move to a different location upon completion of the authentication process.

[Appendix 11] The program according to appendix 8 or 9, wherein
the dispatch destination information includes every user identification for every worker who plans to use the cafeteria facility at the designated location, and
the operations comprise, when an authentication process for every user identification is completed before an end of the designated time period, commanding the vehicle to move to a different location after a first predetermined time from completion of the authentication process.

[Appendix 12] The program according to appendix 8 or 9, wherein
the dispatch destination information includes every user identification for every worker who plans to use the cafeteria facility at the designated location, and
the operations comprise, when an authentication process for every user identification, except a user identification for a worker who has notified a plan cancellation, is completed before an end of the designated time period, commanding the vehicle to move to a different location upon completion of the authentication process.

[Appendix 13] The program according to appendix 8 or 9, wherein
the dispatch destination information includes every user identification for every worker who plans to use the cafeteria facility at the designated location, and
the operations comprise, when an authentication process for every user identification, except a user identification for a worker who has notified a plan cancellation, is completed before an end of the designated time period, commanding the vehicle to move to a different location after a first predetermined time from completion of the authentication process.

[Appendix 14] The program according to any one of appendices 10 to 14, wherein the operations comprise, when the authentication process for every user identification is not completed before a second predetermined time of the end of the designated time period, outputting an alert to a worker with a user identification for which the authentication process has not ended.

[Appendix 15] An information processing method performed by an information processing apparatus configured to manage a vehicle with a cafeteria facility, the information processing method comprising:
acquiring dispatch destination information including a designated location and a designated time period; and
commanding the vehicle to be dispatched to the designated location in the designated time period.

[Appendix 16] The information processing method according to appendix 15, comprising commanding the vehicle to move to a different location from the designated location at an end of the designated time period.

[Appendix 17] The information processing method according to appendix 15 or 16, wherein
the dispatch destination information includes every user identification for every worker who plans to use the cafeteria facility at the designated location, and
the information processing method comprises, when an authentication process for every user identification is completed before an end of the designated time period, commanding the vehicle to move to a different location upon completion of the authentication process.

[Appendix 18] The information processing method according to appendix 15 or 16, wherein
the dispatch destination information includes every user identification for every worker who plans to use the cafeteria facility at the designated location, and
the information processing method comprises, when an authentication process for every user identification is completed before an end of the designated time period, commanding the vehicle to move to a different location after a first predetermined time from completion of the authentication process.

[Appendix 19] The information processing method according to appendix 15 or 16, wherein
the dispatch destination information includes every user identification for every worker who plans to use the cafeteria facility at the designated location, and
the information processing method comprises, when an authentication process for every user identification, except a user identification for a worker who has notified a plan cancellation, is completed before an end of the designated time period, commanding the vehicle to move to a different location upon completion of the authentication process.

[Appendix 20] The information processing method according to appendix 15 or 16, wherein
the dispatch destination information includes every user identification for every worker who plans to use the cafeteria facility at the designated location, and
the information processing method comprises, when an authentication process for every user identification, except a user identification for a worker who has notified a plan cancellation, is completed before an end of the designated time period, commanding the vehicle to move to a different location after a first predetermined time from completion of the authentication process.

1. An information processing apparatus configured to manage a vehicle with a cafeteria facility, the information processing apparatus comprising a controller configured to:
acquire dispatch destination information including a designated location and a designated time period; and
command the vehicle to be dispatched to the designated location in the designated time period.

2. The information processing apparatus according to claim 1, wherein the controller is configured to command the vehicle to move to a different location from the designated location at an end of the designated time period.

3. The information processing apparatus according to claim 1, wherein the controller is configured to:
acquire every user identification for every worker who plans to use the cafeteria facility at the designated location; and
when an authentication process for every user identification is completed before an end of the designated time period, commanding the vehicle to move to a different location upon completion of the authentication process.

4. The information processing apparatus according to claim 1, wherein the controller is configured to:
acquire every user identification for every worker who plans to use the cafeteria facility at the designated location; and
when an authentication process for every user identification is completed before an end of the designated time period, commanding the vehicle to move to a different location after a first predetermined time from completion of the authentication process.

5. The information processing apparatus according to claim 1, wherein the controller is configured to:
acquire every user identification for every worker who plans to use the cafeteria facility at the designated location; and
when an authentication process for every user identification, except a user identification for a worker who has notified a plan cancellation, is completed before an end of the designated time period, commanding the vehicle to move to a different location upon completion of the authentication process.

6. The information processing apparatus according to claim 1, wherein the controller is configured to:
acquire every user identification for every worker who plans to use the cafeteria facility at the designated location; and
when an authentication process for every user identification, except a user identification for a worker who has notified a plan cancellation, is completed before an end of the designated time period, commanding the vehicle to move to a different location after a first predetermined time from completion of the authentication process.

7. The information processing apparatus according to claim 3, wherein when the authentication process for every user identification is not completed before a second predetermined time of the end of the designated time period, the controller is configured to output an alert to a worker with a user identification for which the authentication process has not ended.

8. A non-transitory computer readable medium storing a program configured to cause an information processing apparatus to execute operations, the information processing apparatus being configured to manage a vehicle with a cafeteria facility, the operations comprising:
acquiring dispatch destination information including a designated location and a designated time period; and
commanding the vehicle to be dispatched to the designated location in the designated time period.

9. The non-transitory computer readable medium according to claim 8, wherein the operations comprise commanding the vehicle to move to a different location from the designated location at an end of the designated time period.

10. The non-transitory computer readable medium according to claim 8, wherein
the dispatch destination information includes every user identification for every worker who plans to use the cafeteria facility at the designated location, and
the operations comprise, when an authentication process for every user identification is completed before an end of the designated time period, commanding the vehicle to move to a different location upon completion of the authentication process.

11. The non-transitory computer readable medium according to claim 8, wherein
the dispatch destination information includes every user identification for every worker who plans to use the cafeteria facility at the designated location, and
the operations comprise, when an authentication process for every user identification is completed before an end of the designated time period, commanding the vehicle to move to a different location after a first predetermined time from completion of the authentication process.

12. The non-transitory computer readable medium according to claim 8, wherein
the dispatch destination information includes every user identification for every worker who plans to use the cafeteria facility at the designated location, and
the operations comprise, when an authentication process for every user identification, except a user identification for a worker who has notified a plan cancellation, is completed before an end of the designated time period, commanding the vehicle to move to a different location upon completion of the authentication process.

13. The non-transitory computer readable medium according to claim 8, wherein
the dispatch destination information includes every user identification for every worker who plans to use the cafeteria facility at the designated location, and
the operations comprise, when an authentication process for every user identification, except a user identification for a worker who has notified a plan cancellation, is completed before an end of the designated time period, commanding the vehicle to move to a different location after a first predetermined time from completion of the authentication process.

14. The non-transitory computer readable medium according to claim 10, wherein the operations comprise, when the authentication process for every user identification is not completed before a second predetermined time of the end of the designated time period, outputting an alert to a worker with a user identification for which the authentication process has not ended.

15. An information processing method performed by an information processing apparatus configured to manage a vehicle with a cafeteria facility, the information processing method comprising:
acquiring dispatch destination information including a designated location and a designated time period; and
commanding the vehicle to be dispatched to the designated location in the designated time period.

16. The information processing method according to claim 15, comprising commanding the vehicle to move to a different location from the designated location at an end of the designated time period.

17. The information processing method according to claim 15, wherein
the dispatch destination information includes every user identification for every worker who plans to use the cafeteria facility at the designated location, and
the information processing method comprises, when an authentication process for every user identification is completed before an end of the designated time period, commanding the vehicle to move to a different location upon completion of the authentication process.

18. The information processing method according to claim 15, wherein
the dispatch destination information includes every user identification for every worker who plans to use the cafeteria facility at the designated location, and
the information processing method comprises, when an authentication process for every user identification is completed before an end of the designated time period, commanding the vehicle to move to a different location after a first predetermined time from completion of the authentication process.

19. The information processing method according to claim 15, wherein
the dispatch destination information includes every user identification for every worker who plans to use the cafeteria facility at the designated location, and
the information processing method comprises, when an authentication process for every user identification, except a user identification for a worker who has notified a plan cancellation, is completed before an end of the designated time period, commanding the vehicle to move to a different location upon completion of the authentication process.

20. The information processing method according to claim 15, wherein
the dispatch destination information includes every user identification for every worker who plans to use the cafeteria facility at the designated location, and
the information processing method comprises, when an authentication process for every user identification, except a user identification for a worker who has notified a plan cancellation, is completed before an end of the designated time period, commanding the vehicle to move to a different location after a first predetermined time from completion of the authentication process.
